(19) United States
(12) Patent Application Publication
(10) Pub. No.: US 2026/0180002 A1
(43) Pub. Date: Jun. 25, 2026

(54) Solid-State Battery Pressing Device

(71) Applicant: National Chung Shan Institute of Science and Technology, Taoyuan City (TW)

(72) Inventors: Fu-Min Fang, Taoyuan City (TW); Chih-Hsien Chung, Taoyuan City (TW); Shih-Chang Tseng, Taoyuan City (TW); Gwo-Huei You, Taoyuan City (TW); Kuo-Kuang Jen, Taoyuan City (TW)

(21) Appl. No.: 18/989,575

(22) Filed: Dec. 20, 2024

(51) Int. Cl. H01M 10/04

(52) U.S. Cl. CPC H01M 10/0481; H01M 10/0404

(57) ABSTRACT

A solid-state battery pressing device is provided to include a base, at least two pressing rods, a pressing plate, at least two wedge-shaped pressure blocks, and elastic interfaces. The base accommodates stacked solid-state battery cells. The pressing rods are fixed to both sides of the base with screws through their lower ends. The pressing plate is positioned above the cells, with its sides fixed to the upper ends of the rods. Wedge-shaped pressure blocks, pushed by anti-slip screws, press against the plate's upper edge. Elastic interfaces are placed between the base, cells, and plate.

### BACKGROUND

### Technical Field

The present invention relates to the manufacturing technology of solid-state batteries, particularly to a solid-state battery pressing device used for measuring the pressing level of solid-state battery cells.

### Description of Related Art

Lithium batteries are currently the mainstream power source adopted by major electric vehicle manufacturers worldwide. However, the recurring incidents of electric vehicle fires have raised significant consumer concerns regarding the safety of electric vehicles. Taking Tesla as an example, despite employing Panasonic's cutting-edge battery technology and achieving energy densities approaching the theoretical limit of existing liquid lithium battery technology, the frequent fire incidents pose substantial risks. A single lawsuit could potentially bankrupt a manufacturer. Automakers are held accountable for their designs, which is why they continue to seek batteries that offer high safety while meeting functional requirements.

Solid-state batteries theoretically address two fundamental challenges that currently trouble lithium batteries, particularly in the power battery industry: safety concerns and energy density. Unlike conventional lithium batteries that use liquid electrolytes, solid-state batteries utilize solid electrolytes. This eliminates the risk of electrolyte leakage and, due to the strong isolation effect of solid electrolytes between the cathode and anode, reduces the likelihood of lithium dendrite formation that could lead to short circuits, thereby significantly enhancing safety. In terms of energy density, the superior safety of solid-state batteries allows for the use of materials with higher energy density for both the cathode and anode. For instance, the anode can employ lithium metal, and the cathode can utilize NCMA mixtures, enabling energy densities to potentially exceed those of lithium-ion ternary batteries. The use of non-flammable, non-corrosive, non-volatile, leak-proof, and high-temperature-resistant solid electrolytes in place of liquid electrolytes and separators effectively resolves the issue of spontaneous combustion that leads to vehicle fires.

Solid-state lithium batteries also have their limitations. Generally, solid-state batteries are less suitable for rapid charging and discharging, a performance characteristic or operational requirement essential for vehicles such as electric cars and electric buses. To overcome the inherent limitation of solid-state batteries in rapid charging and discharging, it is necessary to apply a certain degree of pressure (contact pressure) during the assembly of battery cells. This pressure enhances the charging and discharging rates of the solid-state battery. Given the diversity of solid-state battery cells, the required pressure varies depending on the types and proportions of materials used within each cell. Different cell compositions necessitate different levels of applied pressure to optimize performance.

Prior art, such as Chinese patent CN10463810, discloses a charging system for an all-solid-state battery installed in a vehicle. The system is characterized by the inclusion of: a charging unit for charging the all-solid-state battery; a pressurizing unit for applying a constraint pressure to the battery; and a pressure control unit for controlling the constraint pressure. The pressure control unit instructs the pressurizing unit to apply a higher constraint pressure during charging compared to discharging. This design emphasizes dynamically adjusting the constraint pressure on the battery throughout the charging and discharging processes. Consequently, it requires the installation of additional external pressure-sensing devices and a pressurizing mechanism (pressurizing unit) capable of arbitrarily adjusting the applied pressure. The structure and control logic of such a system are complex, leading to high component costs and substantial size. Moreover, factors such as temperature fluctuations and vibrations during battery operation (e.g., while the vehicle is in motion) can compromise the precision of real-time pressure adjustment control.

### SUMMARY

To address the shortcomings of the prior art, some embodiments of the present invention provide a solid-state battery pressing device that comprises a pressing plate, wedge-shaped pressure blocks, anti-slip screws, and fixing screws, for applying pressure to the solid-state battery and adjusting the pressure value. This device can effectively adjust the required pressing pressure for the solid-state battery while reducing the volume of the pressing device. Additionally, the pressing requirements are achieved with a simple mechanism.

The above solid-state battery pressing device comprises a base, at least two pressing rods, a pressing plate, at least two wedge-shaped pressure blocks, and a plurality of elastic interfaces. The base is provided, with a plurality of stacked solid-state battery cells accommodated above the base. The at least two pressing rods are respectively fixed to both sides of the base using fixed screws through the lower ends of the pressing rods. The pressing plate is positioned above the solid-state battery cells, with both sides of the pressing plate being fixed to the upper ends of the pressing rods using additional fixed screws. The at least two wedge-shaped pressure blocks are provided, which are pushed by anti-slip screws to press against both sides of the upper edge of the pressing plate. The inclined surfaces of the wedge-shaped pressure blocks each form an angle with the axial direction of the anti-slip screws. The plurality of elastic interfaces are disposed between the base and the solid-state battery cells, between the solid-state battery cells, and between the solid-state battery cells and the pressing plate.

In an embodiment of this invention, the angles between the inclined surfaces of the at least two wedge-shaped pressure blocks and an axial direction of the anti-slip screws are between 30 degrees and 60 degrees.

In another embodiment of this invention, the plurality of elastic interfaces are PU foam pads or elastic rubber pads.

In yet another embodiment of this invention, the wedge-shaped pressing blocks are made of metal.

In yet another embodiment of this invention, an outer edge of an upper side of the pressing plate has an inwardly tapered angle.

The above summary, along with the following detailed description and accompanying drawings, is provided to further illustrate the methods, means, and effects employed by the present invention to achieve its intended aspects. Other aspects and advantages of the present invention will be elaborated upon in the subsequent description and illustrations.

### BRIEF DESCRIPTION OF THE DRAWINGS

FIG. 1 is a schematic structural diagram of a solid-state battery pressurizing device according to a first embodiment of the present invention.

FIG. 2 is a schematic structural diagram of the solid-state battery pressurizing device according to a second embodiment of the present invention.

### DETAILED DESCRIPTION

The following provides specific examples to illustrate the embodiments of the present invention. Those skilled in the art can readily comprehend other advantages and effects of the present invention based on the disclosures in this specification.

In the first and second embodiments of the present invention and the accompanying illustrations, the terms “upper” and “lower” refer to the orientation disclosed in the diagrams of this specification. Specifically, the relative positional relationship of the pressing plate, the solid-state battery cell, and the base is sequentially arranged from top to bottom. This is hereby clarified in advance.

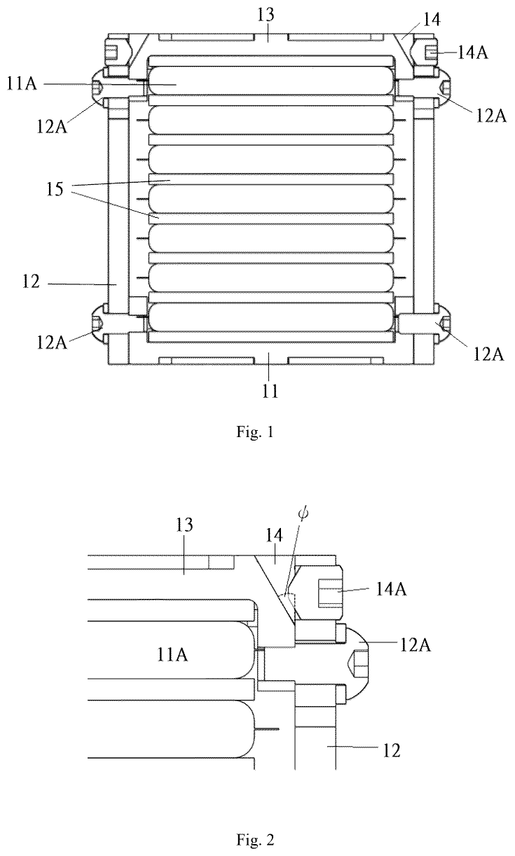

The schematic structural diagram of the solid-state battery pressurizing device according to a first embodiment of the present invention is shown in FIG. 1. This embodiment comprises a base 11, two pressurizing rods 12, a pressurizing plate 13, two wedge-shaped pressure blocks 14, and a plurality of elastic interfaces 15.

The base 11 accommodates a plurality of stacked solid-state battery cells 11A on its upper side. The lower edges of the two pressurizing rods 12 are secured to both sides of the base 11 using fastening screws 12A. The pressurizing plate 13 is positioned above the stacked solid-state battery cells 11A, with its sides secured to the upper edges of the two pressurizing rods 12 using the same fastening screws 12A. The two wedge-shaped pressure blocks 14 are each driven by an anti-slip screw 14A, causing them to adhere to the upper edges of the pressurizing plate 13 on both sides, and are located above the fastening screws 12A on the upper edges of the pressurizing rods 12. The plurality of elastic interfaces 15 are positioned between the base 11 and the solid-state battery cells 11A, between the stacked solid-state battery cells 11A, and between the solid-state battery cells 11A and the pressurizing plate 13.

In one embodiment of the present invention, the base 11, the pressurizing rods 12, and the pressurizing plate 13 are secured together using fastening screws 12A to form a frame-like pressurizing device. In this embodiment, the securing force (locking pressure of the fastening screws 12A) between the base 11 and the pressurizing rods 12 is set to a fixed value. The adjustment of the applied pressure required for different types of solid-state battery cells 11A is achieved through the pressurizing plate 13, the pressurizing rods 12, the wedge-shaped pressure blocks 14, and the anti-slip screws 14A. The user can rotate the anti-slip screws 14A to apply pressure to the wedge-shaped pressure blocks 14, which then transmit the pressure to the pressurizing plate 13, enabling the adjustment of the applied pressure on the plurality of solid-state battery cells 11A.

The schematic structural diagram of the solid-state battery pressurizing device according to the second embodiment of the present invention is shown in FIG. 2, illustrating the pressure adjustment functionality of the wedge-shaped pressure blocks 14 and the anti-slip screws 14A. The pressurizing rods 12 and the pressurizing plate 13 are secured together by fastening screws 12A to ensure their connection. Since the screw-in direction of the fastening screws 12A is perpendicular to the direction in which the pressurizing plate 13 applies pressure to the solid-state battery cells 11A, once the fastening screws 12A are tightened, the pressurizing plate 13 cannot move downward to apply additional pressure. Thus, the pressure on the solid-state battery cells 11A remains fixed and non-adjustable.

If the screw-in direction of the fastening screws 12A is changed to align with the direction in which the pressurizing plate 13 applies pressure to the solid-state battery cells 11A (e.g., screwing in from the top of the pressurizing plate 13 downward), the pressure applied by the pressurizing plate 13 (and its distance from the base 11) would entirely depend on the length of the screw-in of the fastening screws 12A. Variations in the positions of the fastening screws 12A or differences in user operation could affect the precision of the applied pressure, making it difficult to achieve the optimal pressure value for the solid-state battery cells 11A.

To address this issue, the present invention includes wedge-shaped pressure blocks 14 positioned above the pressurizing plate 13. The wedge-shaped pressure blocks 14 have anti-slip screws 14A on their sides, parallel to and above the fastening screws 12A. The outer edge of the upper surface of the pressurizing plate 13 features a recessed angle ψ, which matches the angle between the slanted surface normal of the wedge-shaped pressure blocks 14 and the axial direction of the anti-slip screws 14A.

During operation, the user first screws the anti-slip screws 14A to a specified length, causing the wedge-shaped pressure blocks 14 to displace along the screw-in axial direction. This displacement exerts pressure on the outer edge of the upper surface of the pressurizing plate 13, generating a slanted normal force that applies pressure to the pressurizing plate 13. The pressurizing plate 13 is adjusted to the optimal preload for the target solid-state battery cells 11A using the anti-slip screw 14A and the wedge-shaped pressure block 14. Once the desired preload is achieved, the fastening screws 12A underneath are tightened to secure the setup, allowing the pressurizing device to apply uniform pressure to the internal solid-state battery cells 11A.

In one embodiment of the present invention, the wedge-shaped pressure blocks 14 can be customized with different angles to meet the required pressing pressure values (compression amounts of the elastic interfaces) for the solid-state battery. The recessed angle on the outer edge of the upper surface of the pressurizing plate 13 is preferably between 30 degrees and 60 degrees. For example: When the recessed angle on the outer edge of the upper surface of the pressurizing plate 13 is 30 degrees, adjusting the pressure value (compression amount) using the anti-slip screw 14A results in approximately 1.73 mm of downward displacement of the pressurizing plate 13 for every 1 mm that the anti-slip screw 14A is tightened. When the recessed angle is 45 degrees, the downward displacement of the pressurizing plate 13 is approximately 1 mm for every 1 mm that the anti-slip screw 14A is tightened. When the recessed angle is 60 degrees, the downward displacement of the pressurizing plate 13 is approximately 1 mm for every 1.73 mm that the anti-slip screw 14A is tightened.

In one embodiment of the present invention, assume that each battery cell of the solid-state battery cells 11A exhibits an expansion of 0.6 mm during charging. When pressing is applied to a stack of seven battery cells in series, the total relaxation requirement (stress relaxation) is 4.2 mm. This expansion is absorbed by the elastic interfaces 15 to prevent a sudden pressure spike. Between the pressurizing plate 13 and the battery cells, between the battery cells themselves, and between the battery cells and the base 11, PU foam pads (model 60-20125) are used as spacer elastic interfaces 15 during battery pressing. A total of eight PU foam pads are used, each with a thickness of 3.18 mm, resulting in a total thickness of 25.44 mm. When the solid-state battery pressurizing device of the present invention applies pressure to the entire battery module (a plurality of battery cells), the total thickness of the eight PU foam pads is compressed by 3.64 mm, providing a preload pressure of 0.3 MPa. During battery charging, the cumulative expansion of the battery cells is 4.2 mm. Combined with the pressure generated by preloading the PU foam pads, the system achieves a final balanced pressure of 0.5 MPa.

In one embodiment of the present invention, to accommodate the pressurizing requirements of solid-state battery cells with varying expansion amounts due to different formulations, the invention enables adjustments through the design of the recessed slope angle on the upper edge of the pressurizing plate 13 (in conjunction with the angular design of the corresponding wedge-shaped pressure block 14 and the anti-slip screw 14A), and the selection of elastic interfaces 15 with different stress-strain curve parameters (such as PU foam pads or elastic rubber pads). This configuration fulfills the pressing and pressure adjustment requirements of solid-state batteries.

In one embodiment of the present invention, the wedge-shaped pressure blocks 14 can be made of metal, providing high strength. Users may also consider factors such as insulation, strength, and cost to select wedge-shaped pressure blocks 14 made of alternative materials.

It should be noted that in the embodiment of the present invention, the pressurizing device is configured with the base 11, the pressurizing plate 13 above the base 11, the wedge-shaped pressure block 14, and the anti-slip screw 14A. However, users may adapt the configuration to their specific needs, such as replacing the pressurizing plate 13 on top with a pressurizing plate at the bottom (fixed at the top), using adjustable pressure pressurizing plates on both the upper and lower sides, or changing the design to apply pressure from the left and right sides. The quantity and positioning of the wedge-shaped pressure blocks 14 and anti-slip screws 14A may also vary and are not limited to the content disclosed in this specification.

Thus, the present invention provides a solid-state battery pressurizing device that uses a pressurizing mechanism comprising a pressurizing plate, wedge-shaped pressure blocks, and anti-slip screws to apply an optimal constant pre-pressurizing force to the solid-state battery (battery cell), enhancing the battery's charge and discharge performance and safety. The present invention, through parameters such as pre-pressure, battery cell expansion, and the stress-strain curve of the elastic interface, effectively limits the required pressurizing pressure for the solid-state battery to ensure that the pressure remains within a known optimal working pressure range for the specific type of battery cell, and thus sudden pressure increases during the battery cell's expansion process is prevented. This invention reduces and simplifies the pressure control logic and device volume required for solid-state battery pressurization, achieving both functionality and economic benefits.

The above embodiments are merely exemplary descriptions of the features and effects of the present invention and are not intended to limit the substantive technical content of the present invention. Any person skilled in the art may make modifications and variations to the above embodiments without departing from the spirit and scope of the present invention. Therefore, the scope of protection of the present invention should be defined by the claims set forth in the subsequent patent application.

What is claimed is:

1. A solid-state battery pressing device, comprising:
a base with a plurality of stacked solid-state battery cells accommodated above the base;
at least two pressing rods respectively fixed to both sides of the base using fixed screws through lower ends of the at least two pressing rods;
a pressing plate positioned above the solid-state battery cells, wherein both sides of the pressing plate are fixed to upper ends of the at least two pressing rods using additional fixed screws;
at least two wedge-shaped pressure blocks pushed by anti-slip screws to press against both sides of an upper edge of the pressing plate, wherein an inclined surface of the wedge-shaped pressure blocks each form an angle with an axial direction of the anti-slip screws; and
a plurality of elastic interfaces respectively disposed between the base and the solid-state battery cells, between the solid-state battery cells, and between the solid-state battery cells and the pressing plate.

2. The solid-state battery pressing device of claim 1, wherein the angles between the inclined surfaces of the at least two wedge-shaped pressure blocks and an axial direction of the anti-slip screws are between 30 degrees and 60 degrees.

3. The solid-state battery pressing device of claim 1, wherein the plurality of elastic interfaces are PU foam pads or elastic rubber pads.

4. The solid-state battery pressing device of claim 1, wherein the at least two wedge-shaped pressing blocks are made of metal.

5. The solid-state battery pressing device of claim 1, wherein an outer edge of an upper side of the pressing plate has an inwardly tapered angle.
